(19) United States
(12) Patent Application Publication
(10) Pub. No.: US 2007/0018914 A1
(43) Pub. Date: Jan. 25, 2007

(54) Plasma display device and driving method thereof

(76) Inventors: Joon-Yeon Kim, Yongin-si (KR); Jeong-Nam Kim, Yongin-si (KR); Hak-Cheol Yang, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/490,980

(22) Filed: Jul. 20, 2006

(30) Foreign Application Priority Data
Jul. 21, 2005 (KR) 10-2005-0066267

(51) Int. Cl. G09G 3/28

(52) U.S. Cl. 345/67

(57) ABSTRACT

A plasma display device has a plurality of first and second electrodes extended in a column direction and a plurality of third electrodes extended in a row direction crossing the first and second electrodes. The plasma display device further includes a plurality of display lines and a plurality of discharge cells, the respective display lines being defined between the first and second electrodes, the respective discharge cells being defined by the respective display lines and the respective third electrodes. In such a plasma display device, the plurality of discharge cells are initialized in a reset period, turn-on discharge cells are selected in a plurality of first display lines formed by the plurality of first electrodes and a first group of the second electrodes in a first address period, and turn-on discharge cells are selected in a plurality of second display lines formed by the plurality of first electrodes and a second group of the second electrodes in a first address period. With such a structure, when a single first electrode shares two adjacent display lines, the two display lines may be driven in a single reset period.

### CROSS-REFERENCE TO RELATED APPLICATION

This application claims priority to and the benefit of Korean Patent Application No. 10-2005-0066267 filed in the Korean Intellectual Property Office on Jul. 21, 2005, the entire content of which is incorporated herein by reference.

### BACKGROUND OF THE INVENTION

1. Field of the Invention

The present invention relates to a plasma display device and a driving method thereof.

2. Description of the Related Technology

A plasma display panel (PDP) is a flat panel display that uses plasma generated by a gas discharge to display characters or images.

One frame of the PDP is divided into a plurality of subfields, and each subfield includes a reset period, an address period, and a sustain period. During the reset period, the status of each discharge cell is initialized so as to facilitate an addressing operation on the discharge cell. In the address period, turn-on/turn-off cells are selected and wall charges to the turn-on cells (i.e., addressed cells) are accumulated. During the sustain period, a discharge for displaying an image on the addressed cells occurs.

In the PDP, address electrodes A1 to Am are extended in a column direction, and scan electrodes Y1 to Yn and sustain electrodes X1 to Xn are extended in a row direction. In addition, display lines are formed when discharges are generated between the sustain and scan electrodes, and discharge cells are formed at a discharge space at which the display lines and the address electrodes cross.

U.S. Patent Application Publication No. 2002/0190930 A1 discloses that a single scan electrode is used in common for the two display lines. The U.S. Patent Publication discloses that a plurality of sustain electrodes are divided into odd- and even-numbered sustain electrodes such that two adjacent display lines may share a single scan electrode. Then, a scan electrode and a sustain electrode of a display line are formed with wall charges that can generate an address discharge. In addition, a scan electrode and a sustain electrode of an adjacent display line are formed with wall charges that cannot generate the address discharge. The address discharge is then sequentially generated in one display line and the other adjacent display line so that the turn-on discharge cells are sequentially selected. With such a scheme, the number of scan and sustain electrodes can be reduced by about half in comparison with a PDP device in which a single scan electrode forms a single display line. However, the above-mentioned device requires two reset periods in order for the wall charge states of the scan and sustain electrodes of the adjacent display lines to be differently controlled. Thus, there is a problem in that the reset period becomes longer.

### SUMMARY OF CERTAIN INVENTIVE ASPECTS

One aspect of the present invention has been made in an effort to provide a plasma display device and a driving method thereof having advantages of reducing a reset period and driving two display lines using a single scan electrode. According to one embodiment of the present invention, a driving method of a plasma display device having a plurality of first electrodes, a plurality of second electrodes, a plurality of third electrodes formed crossing the first and second electrodes, and a plurality of display lines and a plurality of discharge cells, the respective display lines being defined between the first and second electrodes and the respective discharge cells being defined by the respective display lines and the respective third electrodes, is provided. The driving method may include initializing the plurality of discharge cells in a reset period, selecting turn-on discharge cells from among a plurality of first display lines formed by the plurality of first electrodes and a first group of the second electrodes in a first address period, and selecting turn-on discharge cells from among a plurality of second display lines formed by the plurality of first electrodes and a second group of the second electrodes in a first address period.

According to another embodiment of the present invention, a plasma display device includes a PDP and a driver. The PDP may include a plurality of first electrodes, a plurality of second electrodes, a plurality of third electrodes formed crossing the first and second electrodes, and a plurality of display lines and a plurality of discharge cells, the respective display lines being defined between the first and second electrodes and the respective discharge cells being defined by the respective display lines and the respective third electrodes. In addition, the driver may initialize the plurality of discharge cells in a reset period, by selecting turn-on discharge cells in a plurality of first display lines formed by the plurality of first electrodes and a first group of the second electrodes in a first address period, and selecting turn-on discharge cells in a plurality of second display lines formed by the plurality of first electrodes and a second group of the second electrodes in a first address period. According to another embodiment of the present invention, a driving method of a plasma display device having a plurality of first electrodes, a plurality of second electrodes, a plurality of third electrodes formed crossing the first and second electrodes, and a plurality of display lines and a plurality of discharge cells, the respective display lines being defined between the first and second electrodes and the respective discharge cells being defined by the respective display lines and the respective third electrodes, is provided. The driving method may includes initializing the plurality of discharge cells in a reset period, and selecting turn-on discharge cells from among a plurality of first display lines formed by the plurality of first electrodes and a first group of the second electrodes in a first address period, wherein the selecting turn-on discharge cells from among the plurality of first display lines includes respectively applying the first and second voltages to the first and second groups of first electrodes and applying a third voltage to the plurality of second electrodes, and applying a fourth voltage having the same polarity as the third voltage to the third electrodes of turn-on discharge cells selected from among the discharge cells formed by the second electrodes applied with the third voltage and applying the second voltage to the first group of the second electrodes.

### BRIEF DESCRIPTION OF THE DRAWINGS

FIG. 1 shows a schematic diagram of a plasma display device according to an exemplary embodiment of the present invention.

FIG. 2 shows an electrode arrangement diagram of a plasma display panel according to the exemplary embodiment of the present invention.

FIG. 3 shows an exploded perspective view of a plasma display device according to one embodiment of the present invention.

FIG. 4 shows a partial sectional view cut away along a line IV-IV of FIG. 3.

FIG. 5 shows a driving waveform diagram of the plasma display device according to another embodiment of the present invention.

FIG. 6 shows wall charge states in a cell after finishing a rising period of the driving waveforms of FIG. 5.

FIG. 7 shows a driving waveform diagram of the plasma display device according to another embodiment of the present invention.

### DETAILED DESCRIPTION OF CERTAIN INVENTIVE EMBODIMENTS

Embodiments of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

The wall charges being described in embodiments of the present invention mean charges formed on a wall close to each electrode of a discharge cell. The wall charge will be described as being “formed” or “accumulated” on the electrode, although the wall charge does not actually touch the electrodes. Further, a wall voltage means a potential difference formed on the wall of the discharge cell by the wall charge.

A plasma display device according to one embodiment of the present invention will hereinafter be described in detail.

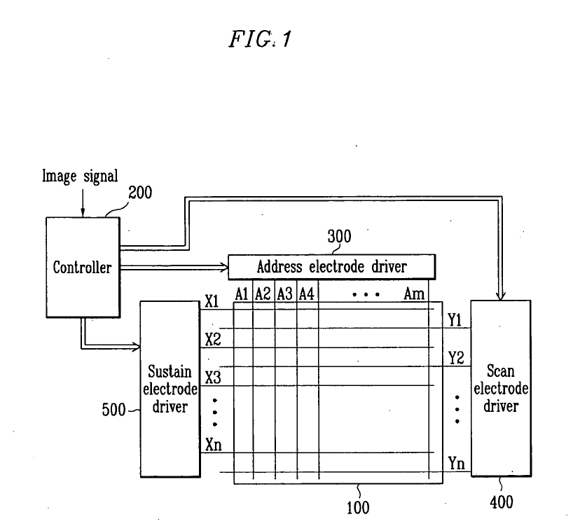

Firstly, a configuration of the plasma display device will be described with reference to FIG. 1 through FIG. 3.

FIG. 1 shows a schematic diagram of the plasma display device according to an exemplary embodiment of the present invention.

As shown in FIG. 1, the plasma display device includes a PDP 100, a controller 200, an address electrode driver 300, a scan electrode driver 400, and a sustain electrode driver 500.

The plasma panel 100 includes a plurality of address electrodes (hereinafter called “A electrodes”) A1 to Am extending in a column direction, a plurality of sustain electrodes (hereinafter called “X electrodes”) X1 to Xn extending in a row direction, and a plurality of scan electrodes (hereinafter called “Y electrodes”) Y1 to Yn also extending in a row direction.

The controller 200 receives an external video signal and outputs an address driving control signal, a sustain electrode driving control signal, and a sustain electrode driving control signal for control of driving the address electrode driver 300, the scan electrode driver 400, and the sustain electrode driver 500. In addition, the controller 200 controls the drivers 300, 400, and 500 by fields, each of which is divided into a plurality of subfields having respective brightness weights. Each subfield includes a reset period, an address period, and a sustain period. In one embodiment, the controller 200 controls the sustain electrode driver 500 to drive a first group of even-numbered X electrodes and a second group of odd-numbered X electrodes from the plurality of X electrodes differently. In another embodiment, the first group may include odd-numbered X electrodes, and the first group may include even-numbered X electrodes

The address electrode driver 300 receives an A electrode driving control signal from the controller 200 and applies a driving voltage to the A electrodes.

The scan electrode driver 400 receives the Y electrode driving control signal from the controller 200 and applies a driving voltage to the Y electrodes.

The sustain electrode driver 500 receives the X electrode driving control signal from the controller 200 and applies a driving voltage to the X electrodes.

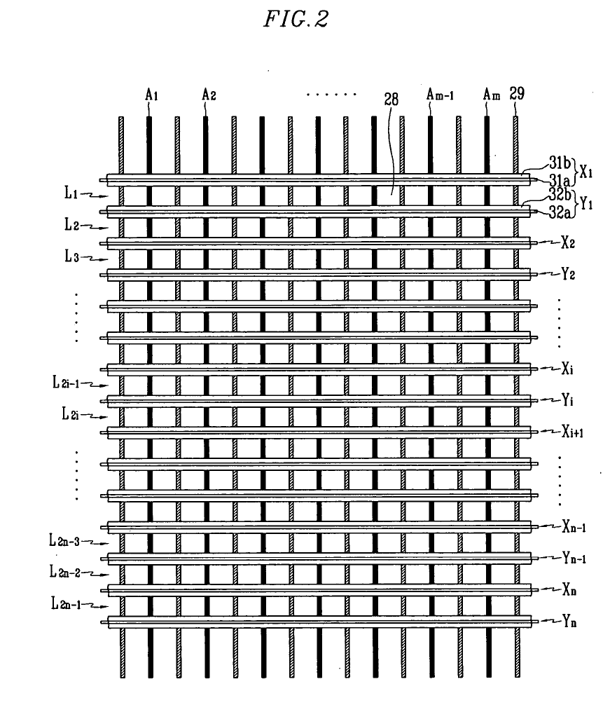

FIG. 2 shows an electrode arrangement diagram of a plasma display panel according to FIG. 1 embodiment.

As shown in FIG. 2, the plasma display panel 100 includes A electrodes extended in a column direction, and X and Y electrodes extended by pairs in a row direction. The plasma display panel 100 includes one substrate having the X and Y electrodes formed thereon, and the other substrate having the A electrodes formed thereon. The two substrates are disposed to face each other. Generally, the X electrodes X1 to Xn are formed to correspond to the respective Y electrodes Y1 to Yn. Display lines L1 to L2n−1 for displaying images are disposed between the Y electrodes (Y1 to Yn) and X electrodes (X1 to Xn). Discharge spaces formed at the areas where these display lines L1 to L2n−1 cross the A electrodes A1 to Am form discharge cells 28. The discharge cells 28 are partitioned by barrier ribs 29. Such X electrodes X1 to Xn and Y electrodes Y1 to Yn include bus electrodes 31a and 32a having a narrow width and transparent electrodes 31b and 32b having a wide width, all of which are extended in a row direction (X-axis direction). The transparent electrodes 31b and 32b are respectively connected with the bus electrodes 31a and 32a.

Such a structure of the PDP 100 is merely one example. Accordingly, other structures of panels may be applied to embodiments of the present invention if the driving waveforms described below can be applied thereto.

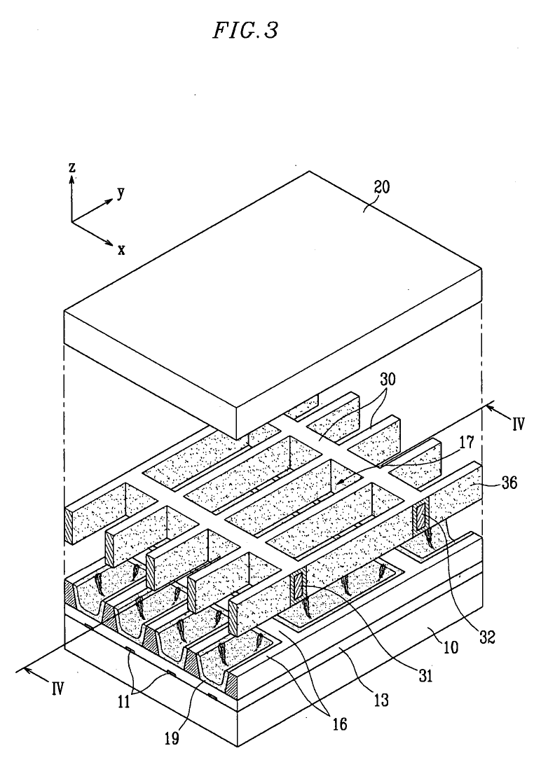

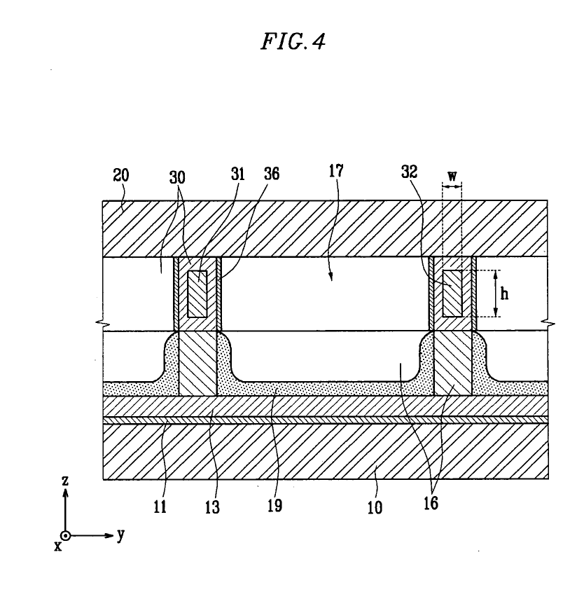

FIG. 3 shows an exploded perspective view of a plasma display device according to one embodiment of the present invention, and FIG. 4 shows a partial sectional view cut away along a line IV-IV of FIG. 3.

As shown in FIG. 3 and FIG. 4, the PDP 100 includes one substrate (hereinafter “a rear substrate 10”) and another substrate (hereinafter “a front substrate 20”) which are opposite to each other with a predetermined distance therebetween. A plurality of discharge cells 17 are formed between the rear substrate 10 and the front substrate 20.

A plurality of A electrodes 11 covered with a dielectric layer 13 are extended along one direction (y-axis direction) on the rear substrate 10. The A electrodes 11 are formed in parallel each other at predetermined intervals. Barrier ribs 16 are formed on the dialectic layer 13 along one direction (y-axis direction) in parallel with the A electrodes 11 and along another direction (x-axis direction) perpendicular thereto. The discharge cells 17 are partitioned by the barrier ribs 16 in such a lattice formation. In addition, phosphor layers 19 are formed on lateral sides of the barrier ribs 16 and on the dielectric layer 13. The red, green, and blue phosphor layers 19 are respectively formed in the cells 17, and colors of the cells are determined thereby. In addition, as shown in FIG. 3 and FIG. 4 although the barrier ribs 16 are formed as a lattice, they may be formed in a stripe pattern or another closed pattern.

A dielectric layer 30 is formed between the front and rear substrates 20 and 10 in a column direction (y axis direction) and in a row direction (x axis direction) corresponding to the barrier ribs. The dielectric layer 30 is formed in a lattice pattern like the barrier ribs 16 so that the dielectric layer also partitions the discharge cells. In addition, the X and Y electrodes are elongated in a row direction (x axis direction) in the dielectric layer 30, and a protective layer 36 is formed on the dielectric layer 30.

A display line (not shown) is formed between the X and Y electrodes 31 and 32 (not shown). Each discharge cell 17 is formed at a discharge space where a display line crosses an A electrode 11. Such X and Y electrodes 31 and 32 are disposed such that each (an individual electrode) of the electrodes 31 and 32 shares two adjacent display lines in a column direction (y axis direction). Accordingly, the X and Y electrodes 31 and 32 respectively participate in a sustain discharge of the discharge cells 17 adjacent at both sides thereof. That is, the X and Y electrodes 31 and 32 are formed as an opposed discharge structure, interposing a discharge cell 17 therebetween. The X and Y electrodes 31 and 32 have a longer length (h) in the z axis direction perpendicular to the substrates 10 and 20 than a length (W) in the row direction (i.e., y axis direction). Therefore, the opposed area of the X and Y electrodes 31 and 32 increases so that an opposed discharge may be more easily induced therebetween.

According to one embodiment of the present invention, the number of X and Y electrodes can be significantly reduced in comparison with the conventional structure that shares a single discharge cell because the X and Y electrodes, respectively, share two adjacent discharge cells. For example, when the 512 display lines are driven, a plasma display device in which the X and Y electrodes share a single discharge cell needs 512 X and Y electrodes. However, according to one embodiment of the present invention, the plasma display device needs about half of the 512 X and Y electrodes since each electrode shares two adjacent discharge cells 17.

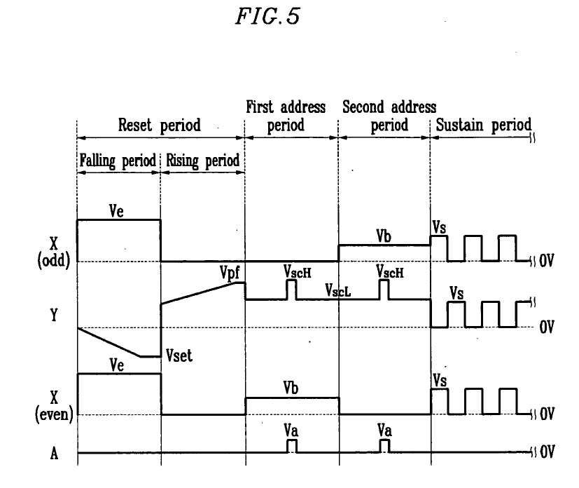

A driving waveform of a plasma display device according to one embodiment of the present invention will be described with reference to FIG. 5. For convenience of description, it will be described based on only two adjacent cells (for example, one cell defined by X1, Y1 and A1, and the other cell defined by Y1, X2 and A1) formed with a pair of X electrodes, a single Y electrode, and a single A electrode.

As shown in FIG. 5, in the falling period of the reset period, the voltage of the Y electrode is gradually decreased from 0V to a voltage Vset while the voltage Ve is applied to the first and second groups of X electrodes and the reference voltage (0V in FIG. 5) is applied to the A electrodes. FIG. 5 illustrates that the voltage of the Y electrode decreases in a ramp style. A weak discharge is generated between the Y and X electrodes and between Y and A electrodes while the voltage of the Y electrode decreases, and (+) wall charges are formed on the Y electrode and (−) wall charges are formed on the X and A electrodes.

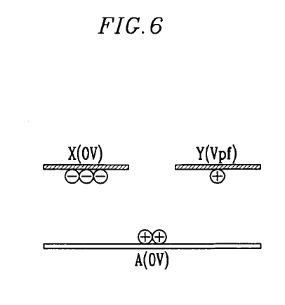

In the rising period of the reset period, the voltage of the Y electrode gradually increases from a voltage Vs to a voltage Vpf while the voltage of the first and second groups of X electrodes is maintained at the reference voltage. Then, a weak discharge is generated between the Y and X electrodes and between the Y and A electrodes while the voltage of the Y electrode increases, and accordingly, the (+) wall charges formed on the Y electrode and the (−) wall charges formed on the X and A electrodes are eliminated so that the discharge cells are initialized. In the falling period of the reset period, the potential of the X electrode is higher than that of the A electrode so that a lesser (−) wall charge is formed on the A electrode than on the X electrode. Then, in the rising period of the reset period, a weak discharge is generated between the X and Y electrodes, and accordingly all the (−) wall charges formed on the A electrode are eliminated and the (+) wall charges are formed on the A electrodes. In this case, the wall charge may be formed on each electrode as shown in FIG. 6 at the end of the rising period.

In addition, the voltage Vpf may be set to be close to a discharge firing voltage between the Y and X electrodes. Then, a wall voltage between the Y and X electrodes approaches 0V after the reset period has finished, and therefore a cell that has not been addressed with an address discharge in the address period may be prevented from misfiring in the sustain period.

In order to select a turn-on discharge cell in the first address period, a positive scan voltage VscH is sequentially applied to the Y electrodes while a positive voltage Vb is applied to the second group of X electrodes (even) and 0V is applied to the first group of X electrodes (odd), wherein the scan voltage VscH may be set to be greater than or equal to the voltage Vpf. At this time, a positive address voltage Va is applied to the A electrodes passing through the turn-on discharge cells among a plurality of discharge cells defined by 1) the Y electrodes applied with the scan voltage VscH, 2) the first group of the X electrodes (odd) and the A electrodes. In addition, a voltage VscL, which is less than the scan voltage VscH, is applied to the Y electrodes which is not applied with the scan voltage VscH. 0V is applied to the A electrodes which is not to be selected. Then, the address discharges are generated between the Y electrodes (applied with the scan voltage VscH) and the first group of X electrodes (odd). Accordingly, the (−) wall charges are formed on the Y electrodes adjacent to the first group of X electrodes (odd) and the (+) wall charges are formed on the first group of X electrodes so that the turn-on discharge cells may be selected. In such a first address period, the turn-on discharge cells are selected from the display lines formed by the first group of X electrodes (odd) and the Y electrodes.

Generally, when the voltage Vpf is applied in the rising period of the reset period, a sum of the wall voltage between the X and Y electrodes and the external voltage Vpf between the X and Y electrodes reaches the discharge firing voltage between the X and Y electrodes. When 0V is applied to the first group of X electrodes (odd) and the voltage VscH(=Vpf) is applied to the Y electrodes in the first address period, the voltage Vfay is formed between the X and Y electrodes, and accordingly the discharge may be expected to be generated. In this case, the discharge is not generated because a discharge delay is greater than the width of the scan pulse and the address pulse. However, if the voltage Va is applied to the A electrode and the voltage VscH is applied to the Y electrode, an electric field is formed between the A and the first (odd) electrodes as well as between the Y and the first (odd) electrodes, and accordingly the discharge may be generated between the X and Y electrodes. At this time, in order to easily generate an address discharge, the voltage VscH may be set to be greater than the voltage Vpf.

Meanwhile, since a voltage Vb is applied to the second group of X electrodes (even) in the first address period, the voltage difference between the Y electrodes and the second group of X (even) electrodes is smaller than the discharge firing voltage between the X and Y electrodes. In this case, almost no address discharge occurs between the second group of X (even) electrodes and the Y electrodes.

In the second address period, a positive scan voltage VscH is sequentially applied to the Y electrodes while the voltage Vb is applied to the first group of X electrodes and the reference voltage is applied to the second group of X electrodes (even). At this time, the address voltage Va is applied to the A electrodes passing through the turn-on discharge cells among the plurality of discharge cells defined by the Y electrodes applied with the san voltage VscH. In addition, the voltage VscL is applied to the Y electrodes which are not applied with the scan voltage VscH, and 0V is applied to the A electrodes which is not to be selected. Then, the address discharges are generated between the Y electrodes (applied with the scan voltage VscH) and the second group of X electrodes. Accordingly, the (−) wall charges are formed on the Y electrodes adjacent to the second group of X electrodes and the (+) wall charges are formed on the second group of X electrodes so that the turn-on discharge cells may be selected. In such a second address period, the turn-on discharge cells are selected from the display lines formed by the second group of X electrodes (even) and the Y electrodes.

Meanwhile, in order to perform such operations in the first and second address periods, the scan electrode driver 400 selects the Y electrodes to be applied with the voltage VscH from among the plurality of Y electrodes in the respective first and second address periods, and the address electrode driver 300 selects the A electrodes to be applied with the address voltage Va among the A electrodes A1-Am passing through the cells formed by the corresponding Y electrode when one of the Y electrodes is selected.

In the sustain period, the sustain pulse alternately having a high-level voltage (voltage Vs of FIG. 6) and a low-level voltage (0V of FIG. 6) is applied to the Y and X electrodes in reverse phases. Accordingly, the sustain discharge may occur between the X and Y electrodes of the turn-on discharge cell. That is, 0V may be applied to the Y electrodes when the voltage Vs is applied to the X electrodes, and 0V may be applied to the X electrodes when the voltage Vs is applied to the Y electrodes. In the first and second address periods, the address discharge may occur between the X and Y electrodes by the voltage Vs and the wall voltage formed between the X and Y electrodes by the address discharge. Thereafter, the process for applying the sustain pulses to the X and Y electrodes is repeated a number of times corresponding to the weight value displayed by the corresponding subfield.

As such, according to one embodiment of the present invention, the address discharge of the adjacent discharge cells may be controlled when the plurality of X electrodes are divided into the two groups and the voltages applied to the two groups of X electrodes in the address period are differentiated. Therefore, the reset period can be reduced because one reset period is sufficient for the two address discharges. In at least one embodiment, a substantially same (or similar) voltage signal (wave form) is applied to 1) one of the first group of the X electrodes and 2) one of the second group of the X electrodes, wherein both of the 1) and 2) X electrodes are adjacent to the same Y electrode in a reset period as shown in FIG. 5.

In addition, a driving waveform which is different from that of the FIG. 5 embodiment may be applied.

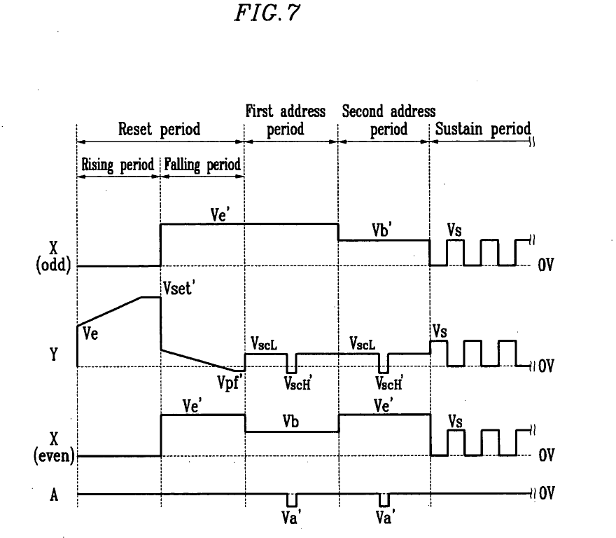

FIG. 7 shows a driving waveform diagram of the plasma display device according to another embodiment of the present invention.

As shown in FIG. 7, in the reset period and address period, a driving waveform is as the same as the driving waveform shown in FIG. 5, except that these waveforms have a reverse polarity and the absolute value of the voltages applied to the X and Y electrodes is greater by the voltage Ve than that of the corresponding voltage applied to the X and Y electrodes in the driving waveform of FIG. 5. In the sustain period, a driving waveform of the voltages applied to the X and Y electrodes is as the same as the driving waveform shown in FIG. 5, except that the voltages applied to the X and Y electrodes have a reverse polarity. In the reset period, address period, and sustain period, a driving waveform of the voltages applied to the A electrodes is the same as the driving waveform shown in FIG. 5, except that the voltages applied to the A electrodes have a reverse polarity. Accordingly, a voltage difference between the X and Y electrodes is the same as that of FIG. 5. Therefore, the second exemplary embodiment of the present invention may use the same driving method and have the same effect as that of the first exemplary embodiment of the present invention.

In addition, in the embodiments of FIGS. 5 and 7, the same voltages are applied to the Y and A electrodes. However, different voltages may be applied to the Y and A electrodes. For example, when the voltage VscH is applied in the first address period, a voltage greater than the voltage VscH may be applied in the second address period. Also, when the voltage Va is applied in the first address period, a voltage greater than the voltage Va may be applied in the second address period. Since the priming particles and/or wall charges formed by the discharge have been gradually reduced, the address discharge may become unstable at the delayed address period. However, when the voltage applied to the A and Y electrodes in the delayed second address period is set to be greater, the address discharge may become stable.

As described above, the number of scan ICs for selecting the turn-on discharge cells in the address period X electrode can be reduced because each of the X and Y electrodes shares two adjacent discharge cells.

In addition, when each of the X and Y electrodes shares the two adjacent discharge cells, the plurality of X electrodes are divided into two groups and different voltages are applied to the respective groups of X electrodes in the address period such that the turn-on discharge cells are selected in one group and then the other group. With such structure, a reset period can be reduced because the two reset periods are not required for the respective groups of X electrodes.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of driving a plasma display device including i) a plurality of first electrodes, ii) a plurality of second electrodes, iii) a plurality of third electrodes crossing the first and second electrodes, iv) a plurality of display lines and v) a plurality of discharge cells, the respective display lines being defined by the first and second electrodes, the respective discharge cells being defined by the respective display lines and the respective third electrodes, the driving method comprising:
initializing the plurality of discharge cells in a reset period, wherein a substantially similar voltage signal is applied to each of the second electrodes of two selected adjacent discharge cells which share a selected one of the first electrodes;
first selecting turn-on discharge cells from a plurality of first display lines defined by the plurality of first electrodes and a first group of the second electrodes in a first address period, and
second selecting turn-on discharge cells from a plurality of second display lines defined by the plurality of first electrodes and a second group of the second electrodes in a second address period.

2. The driving method of claim 1, wherein the first selecting includes applying a first voltage to the first group of the second electrodes and applying a second voltage greater than the first voltage to the second group of the second electrodes,
and the second selecting includes applying the first voltage to the second group of the second electrodes and applying the second voltage to the first group of the second electrodes.

3. The driving method of claim 2, wherein the first selecting includes sequentially applying a first scan voltage to the plurality of first electrodes and applying a second scan voltage lower than the first scan voltage to the remaining first electrodes,
and the second selecting includes sequentially applying a second scan voltage to the plurality of first electrodes and applying a third scan voltage lower than the second scan voltage to the remaining first electrodes.

4. The driving method of claim 3, wherein the first selecting further comprises applying an address voltage to the third electrodes passing through the turn-on cells associated with the first electrodes which are applied with the first scan voltage,
and the second selecting further comprises applying an address voltage to the third electrodes passing through the turn-on cells associated with the second electrodes which are applied with the second scan voltage.

5. The driving method of claim 4, wherein the first selecting includes applying a voltage lower than the address voltage to the third electrodes which are not applied with the address voltage, and the second selecting includes applying a voltage lower than the address voltage to the third electrodes which are not applied with the address voltage.

6. The driving method of claim 2, wherein the initializing includes:
gradually decreasing a voltage of the first electrodes while a third voltage is applied to the plurality of second electrodes, and
gradually increasing the voltage of the first electrodes while a fourth voltage lower than the third voltage is applied to the plurality of second electrodes.

7. The driving method of claim 6, wherein the gradually decreasing includes applying a fifth voltage lower than the third voltage to the plurality of third electrodes, and the gradually increasing includes applying the fourth voltage to the plurality of third electrodes.

8. The driving method of claim 1, further comprising alternately applying a sixth voltage and a seventh voltage lower than the sixth voltage to the plurality of first and second electrodes in a sustain period.

9. The driving method of claim 8, wherein one group of the first and second groups includes odd-numbered second electrodes and the other group thereof includes even-numbered second electrodes, and wherein the first and second electrodes are alternately formed with respect to each other.

10. A plasma display device comprising:
a plurality of first electrodes and a plurality of second electrode;
a plurality of third electrodes formed so as to cross the first and second electrodes;
a plurality of display lines defined by adjacent first and second electrodes;
a plurality of discharge cells defined by the respective display lines and the respective third electrodes; and
a driver configured to i) initialize the plurality of discharge cells in a reset period, ii) select turn-on discharge cells in a plurality of first display lines defined by the plurality of first electrodes and a first group of the second electrodes in a first address period, and iii) select turn-on discharge cells in a plurality of second display lines defined by the plurality of first electrodes and a second group of the second electrodes in a second address period, wherein a substantially similar voltage signal is applied to each of the second electrodes of two selected adjacent discharge cells which share a selected one of the first electrodes.

11. The plasma display device of claim 10, wherein the driver is configured to apply a first voltage to the first group of the second electrodes and apply a second voltage greater than the first voltage to the second group of the second electrodes in the first address period, and apply the first voltage to the second group of the second electrodes and apply the second voltage to the first group of the second electrodes in the second address period.

12. The plasma display device of claim 11, wherein the driver is configured to sequentially apply a first scan voltage to the plurality of first electrodes and apply a second scan voltage lower than the first scan voltage to the remaining first electrodes,
and sequentially apply a second scan voltage to the plurality of first electrodes and applies a third scan voltage lower than the second scan voltage to the remaining first electrodes.

13. The plasma display device of claim 12, wherein the driver is configured to apply a seventh voltage to the third electrodes passing through the turn-on cells associated with the first electrodes which are applied with the third voltage in the first address period,
and apply an eighth voltage to the third electrodes passing through the turn-on cells associated with the first electrodes which are applied with the fifth voltage in the second address period.

14. The plasma display device of claim 10, wherein:
during a first period of the reset period, the driver is configured to gradually decrease a voltage difference of the first electrodes with respect to the second electrodes and a voltage difference of the first electrodes with respect to the third electrodes; and
during a second period of the reset period, the driver is configured to gradually increase the voltage difference of the first electrodes with respect to the second electrodes and the voltage difference of the first electrodes with respect to the third electrodes,
wherein in the first reset period, an absolute value of a final voltage of the voltage difference of the first electrodes with respect to the second electrodes is greater than a final voltage of the voltage difference of the first electrodes with respect to the third electrodes.

15. The plasma display device of claim 14, wherein one group of the first and second groups includes odd-numbered second electrodes and the other group thereof includes even-numbered second electrodes.

16. A method of driving a plasma display device including i) a plurality of first electrodes, ii) a plurality of second electrodes, iii) a plurality of third electrodes, iv) a plurality of display lines and v) a plurality of discharge cells, the respective display lines being defined by the first and second electrodes, the respective discharge cells being defined by the respective display lines and the respective third electrodes, the driving method comprising:
initializing the plurality of discharge cells in a reset period; and
first selecting turn-on discharge cells from a plurality of first display lines defined by the plurality of first electrodes and a first group of the second electrodes in a first address period; and
second selecting turn-on discharge cells from a plurality of second display lines defined by the plurality of first electrodes and a second group of the second electrodes in a second address period,
applying the first and second voltages to the first and second groups of the second electrodes, respectively, and applying a third voltage to the plurality of first electrodes,
and applying a fourth voltage having the same polarity as the third voltage to the third electrodes of turn-on discharge cells associated with the second electrodes which are applied with the third voltage,
wherein different voltage signals are applied to the second electrode of a selected discharge cell in the first and second address periods.

17. The driving method of claim 16,
wherein the first selecting comprises:
applying the first and second voltages to the first and second groups of the second electrodes, respectively, and applying a third voltage to the first electrodes; and
applying the fourth voltage to the third electrodes of turn-on discharge cells associated with the second electrodes which are applied with the third voltage.

18. The driving method of claim 17, further comprising applying a fifth voltage lower than the third voltage to the first electrodes which are not applied with the third voltage, wherein the first voltage is lower than the second voltage.

19. The driving method of claim 18, further comprising applying the fifth voltage greater than the third voltage to the first electrodes which are not applied with the third voltage, wherein the first voltage is greater than the second voltage.
